(19) United States
(12) Patent Application Publication
(10) Pub. No.: US 2008/0006713 A1
(43) Pub. Date: Jan. 10, 2008

(54) FUEL INJECTOR HAVING AN INTERNALLY MOUNTED CROSS-FLOW NOZZLE FOR ENHANCED COMPRESSED NATURAL GAS JET SPRAY

(76) Inventor: James R. Parish, Yorktown, VA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/428,946

(22) Filed: Jul. 6, 2006

(51) Int. Cl. F02D 1/06

(52) U.S. Cl. 239/5; 239/533.12; 239/533.2

(57) ABSTRACT

A compressed natural gas fuel injector having a housing, an inlet, an outlet, a seat, a closure member, and an internally mounted nozzle. In a preferred embodiment, the inlet and outlet communicate a flow of gaseous fuel regulated by the closure member. The gaseous fuel passes through the seat, which is secured to a rim surface of a retainer portion of the internally mounted nozzle, and into a flow passage that further communicates the flow of gaseous fuel into one or more flow channels. The orientation of the flow channels within the internally mounted nozzle greatly affects the discharge pattern and mixing characteristics of the gaseous fuel within an intake manifold. A method of flowing gaseous fuel through the fuel injector is also described.

### BACKGROUND OF INVENTION

In the case of internal combustion engines having injection systems, fuel injectors are conventionally used to provide a precise amount of fuel needed for combustion. Compressed-Natural-Gas (hereinafter sometimes referred to as “CNG”) is a common automotive fuel for commercial fleet vehicles and residential customers. In vehicles, the CNG is delivered to the engine in precise amounts through fuel injectors, hereinafter referred to as “CNG injectors”, or simply “fuel injectors.” Typically, the CNG injector is required to deliver the precise amount of fuel per injection pulse and maintain this accuracy over the life of the injector. In order to improve the combustion of fuel, certain strategies are required in the design of CNG injectors. These strategies are keyed to the delivery of gaseous fuel into the intake manifold of the internal combustion engine in precise amounts and flow patterns.

It is believed that some conventional CNG injector designs have failed to achieve suitable combustion of gaseous fuel injected into the intake manifold of an internal combustion engine. Specifically, such design of CNG injectors may reduce air flow or even cause back-flow of the air-fuel mixture into the internal combustion engine's intake plenum or into other engine cylinders thereby causing engine misfire and other drivability problems.

### SUMMARY OF THE INVENTION

The present invention provides improved gaseous fuel targeting and fuel distribution with an external nozzle design for a fuel injector that alleviates these drawbacks of the known gaseous fuel injector.

In one aspect of the present invention, a fuel injector is provided that dispenses gaseous fuel. The fuel injector includes a housing, an inlet, an outlet, a seat, a closure member, and an external nozzle. The inlet and outlet communicate with a flow of gaseous fuel that is regulated by the closure member disposed in at least two positions along the longitudinal axis. The closure member is disposed in at least two positions along the longitudinal axis in the passage. The closure member has an imperforate contact portion proximate the outlet. The seat is disposed in the passage proximate the outlet. The seat includes a sealing surface contiguous to the imperforate contact portion of the closure member in one position of the closure member to occlude flow through a seat orifice extending through the seat from the sealing surface along the longitudinal axis. The flow modifier has a retainer portion and flow modifier portion. The retainer portion is contiguous to an inner surface of the body such that the flow modifier portion extends outside the body. The flow modifier includes a first flow modifier surface and a second flow modifier surface. The first flow modifier surface is disposed about the longitudinal axis to define a flow passage in fluid communication with the seat orifice. The second flow modifier surface is disposed along and about a first axis at an angle with respect to the longitudinal axis to define at least a flow channel.

In yet another aspect of the present invention, a method of flowing gaseous fuel through a fuel injector is provided. The fuel injector has an inlet and an outlet and a passage that extends along a longitudinal axis from the inlet to the outlet, a closure member, a seat, and a flow modifier. The closure member is disposed in at least two positions along the longitudinal axis in the passage. The seat is disposed in the passage proximate the outlet having a seat orifice extending through the seat. The method can be achieved by: preventing fluid communication past the seat with an imperforate portion of the closure member contiguous the seat; locating a portion of a flow diverter within the fuel injector; flowing gaseous fuel through the flow diverter; and dispersing the gaseous fuel into at least one column of gaseous fuel that extends at a first angle with respect to the longitudinal axis.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 illustrates a cross-sectional view of the preferred embodiment of the gaseous fuel injector and internally mounted nozzle.

FIG. 2 illustrates a close-up perspective view of the gaseous fuel injector and internally mounted nozzle with spray distribution pattern from four flow channels.

FIG. 3 illustrates a close-up cross-sectional view of the preferred embodiment of an internally mounted nozzle that, in particular, shows the various relationships between various surfaces in the internally mounted nozzle.

FIG. 4 illustrates a cross-sectional view of another preferred embodiment of another internally mounted nozzle where a flow channel is oblique to the longitudinal axis.

### DETAILED DESCRIPTION OF THE PREFERRED EMBODIMENT

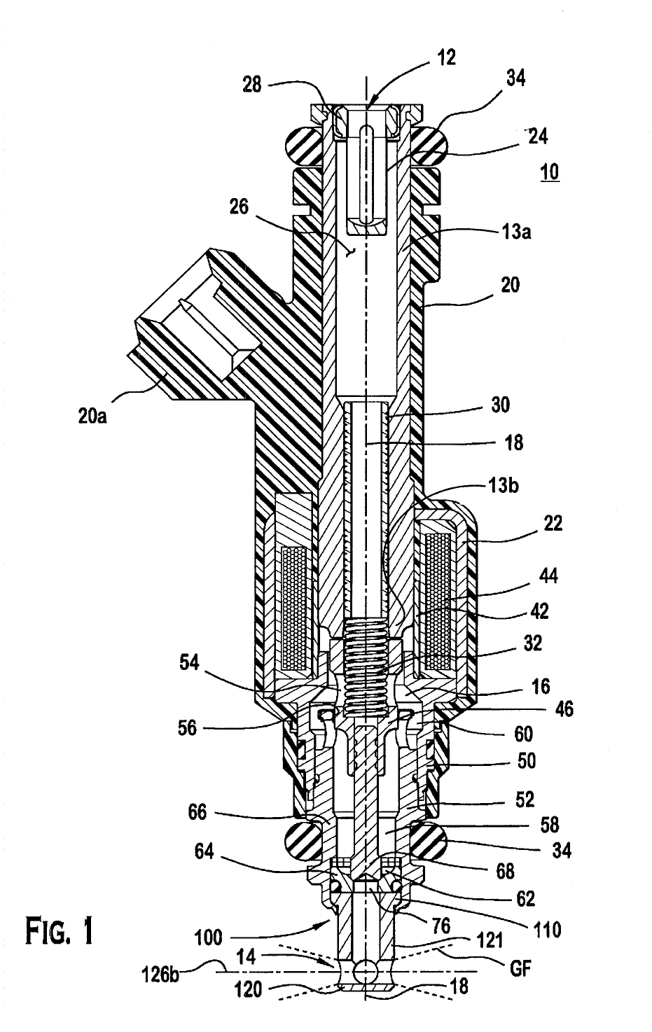

FIGS. 1-4 illustrate the preferred embodiments. In particular, FIG. 1 illustrates a high-pressure injector 10 that dispenses gaseous fuel such as, for example, compressed-natural-gas (“CNG”). The gaseous fuel injector 10 has a housing, which includes a fuel inlet 12, a fuel outlet 14, and a fuel passageway extending from the inlet 12 to the outlet 14 along a longitudinal axis 18. The housing includes an overmolded plastic member 20 cincturing a coil housing 22.

A fuel filter 24 is connected to an inlet tube 13a, which in the preferred embodiments is integral with a pole piece 13b but can be separate components coupled to each other. A portion of the inlet tube 13a is disposed in the overmolded plastic member 20, which includes inlet passage 26. The inlet passage 26 serves as part of the gaseous fuel passageway of the gaseous fuel injector 10. A fuel filter retainer member 28 and a preload adjusting tube 30 are provided in the inlet passage 26. The adjusting tube 30 is positionable along the longitudinal axis 18 before being secured in place, thereby varying the length of an armature bias spring 32. In combination with other factors, the length of the spring 32 controls the quantity of gaseous fuel flow through the gaseous fuel injector 10. The overmolded plastic member 20 also supports an electrical connector 20a that receives a plug (not shown) to operatively connect the gaseous fuel injector 10 to an external source of electrical potential, such as an electronic control unit ECU (not shown). An elastomeric O-ring 34 is provided in a groove on an exterior extension of the inlet member 24. The O-ring 34 sealingly secures the inlet member 24 to a gaseous fuel supply member (not shown), such as a fuel rail and an outlet 14 to an intake manifold such as, for example, the intake manifolds shown in copending Application entitled “Fuel Injection System with Cross-Flow Nozzle for Enhanced Compressed Natural Gas Jet Spray” (Attorney Docket No. Siemens 2006P13279US (051252-5299), which is incorporated by reference in its entirety herein this application.

The coil housing 22 encloses a coil assembly 40 as shown in FIG. 1. The coil assembly 40 includes a bobbin 42 that retains a coil 44. The ends of the coil assembly 40 are electrically connected to the connector 20a of the overmolded plastic member 20. An armature 46 is supported for relative movement along the axis 18 with respect to the inlet member 24. The armature 46 is supported by a body shell 50 and a body 52 via armature guide eyelet 56. The armature 46 has an armature passage 54 in fluid communication with the inlet passage 26.

The body shell 50 engages the body 52. The armature guide eyelet 56 is located on an inlet portion 60 of the body 52 so as to contact the armature 46. An axially extending body passage 58 connects the inlet portion 60 of the body 52 with an outlet portion 62 of the body 52. The armature passage 54 of the armature 46 is in fluid communication with the body passage 58 of the body 52. A seat 64, which is preferably a metallic material, is mounted at the outlet portion 62 of the body 52.

As shown in FIG. 1, the body 52 includes a neck portion 66 that extends between the inlet portion 60 and the outlet portion 62. The neck portion 66 can be an annulus that surrounds a closure member 68. The closure member 68 is operatively connected to the armature 46, and can be a substantially cylindrical needle. The closure member 68 is centrally located within and spaced from the neck portion so as to define a part of the body passage 58. The closure member 68 is axially aligned with the longitudinal axis 18 of the gaseous fuel injector 10 also includes an inward conical taper 68a on the bottom surface of the closure member 68. Features of the gaseous fuel injector 10 are also disclosed in commonly assigned, commonly filed (application Ser. No. 11/427,911) application entitled “Fuel Injector Having An External Cross-Flow Nozzle For Enhanced Compressed Natural Gas Jet Spray,” Attorney Docket no. 2006P13264US, filed on Jun. 30, 2006 by the same inventor, the disclosure of which is incorporated herein by reference.

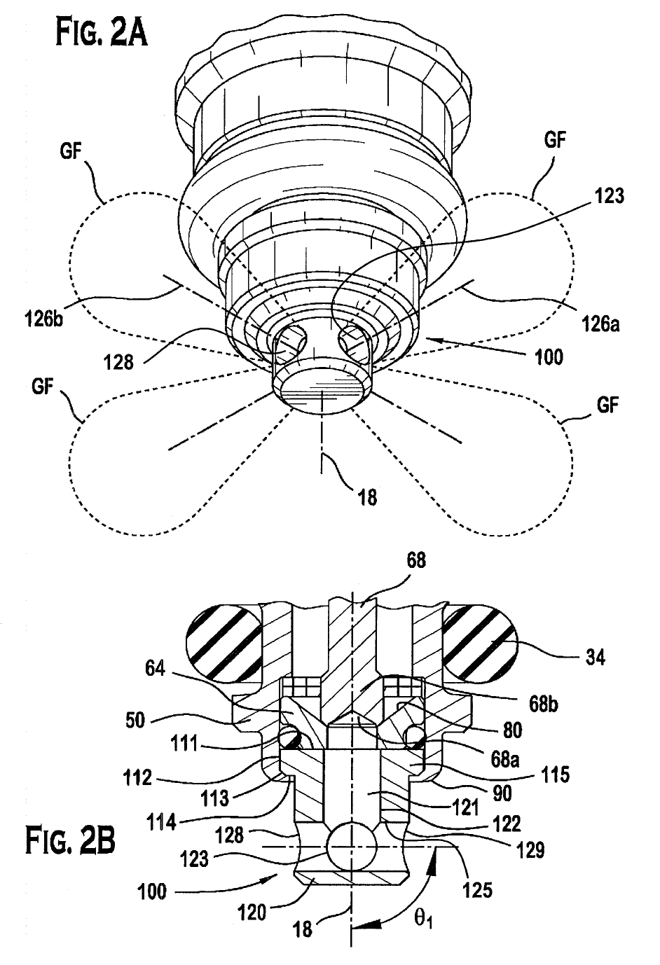

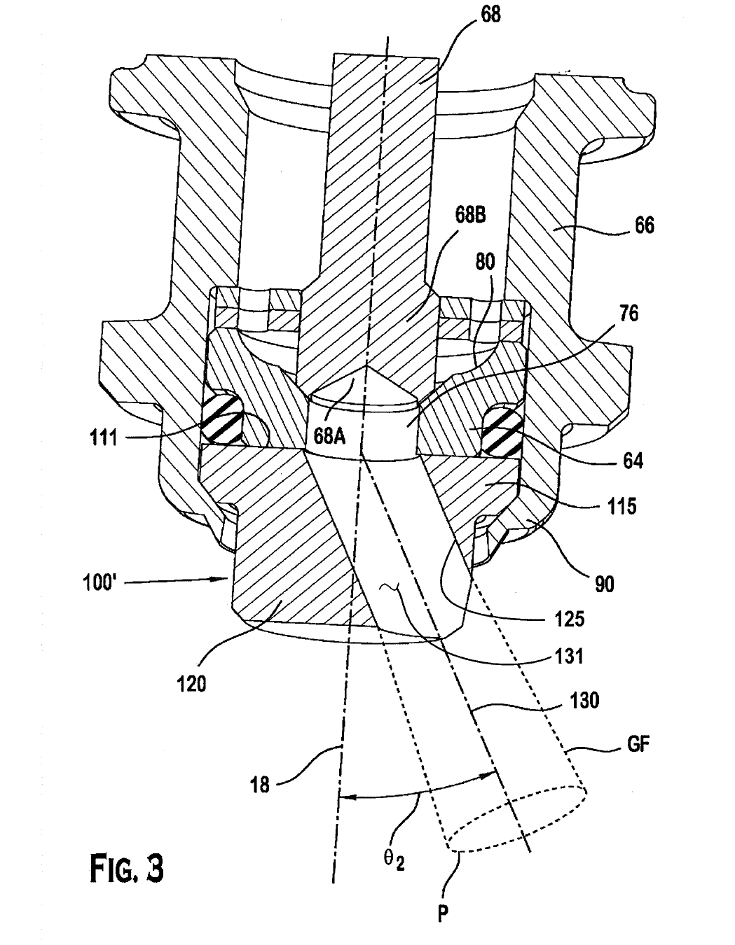

Operative performance of the gaseous fuel injector 10 is achieved by magnetically coupling the armature 46 to the end of the inlet member 26 that is closest to the inlet portion 60 of the body 52. Thus, the lower portion of the inlet member 26 that is proximate to the armature 46 serves as part of the magnetic circuit formed with the armature 46 and coil assembly 40. The armature 46 is guided by the armature guide eyelet 56 and is responsive to an electromagnetic force generated by the coil assembly 40 for axially reciprocating the armature 46 along the longitudinal axis 18 of the gaseous fuel injector 10. The electromagnetic force is generated by current flow from the ECU (not shown) through the coil assembly 40. Movement of the armature 46 also moves the closure member 68. The closure member 68 opens and closes the seat orifice 76 of the seat 64 to permit or inhibit, respectively, gaseous fuel from exiting the outlet of the gaseous fuel injector 10. In order to permit flow through the seat orifice 76, the seal between the tip of closure member 68 and the seat 64 is broken by upward movement of the closure member 68. The closure member 68 moves upwards when the magnetic force is substantially higher than needed to lift the armature needle assembly against the force of spring 32. In order to close the seat orifice 76 of the seat 64, the magnetic coil assembly 40 is de-energized. This allows the tip of closure member 68 to re-engage .surface 80 of seat 64 and close passage 76. During operation, gaseous fuel flows from the fuel inlet source (not shown) through the fuel inlet passage 26 of the inlet member 24, the armature passage 54 of the armature 46, the body passage 58 of the body 52, and the seat orifice 76 of the seat 64 and is injected as gaseous fuel column GF from the outlet 14 of the gaseous fuel injector 10 (FIG. 2A). The gaseous fuel column GF is generally in the preferred form of a cone with an outer perimeter P surrounding a central axis of the cone (FIG. 3).

As shown in FIGS. 2A and 2B, an internally mounted nozzle 100 located proximate to the outlet of the gaseous fuel injector 10, includes a retainer portion 110 and a flow modifier portion 120. The internally mounted nozzle 100 may be made from a suitable material for gaseous fuel. Preferably, the internally mounted nozzle may be made from a metallic material, most preferably stainless steel.

The retainer portion 110 of the internally mounted nozzle engages numerous surfaces of a locking portion 90 as shown in FIG. 2B. A first retainer surface 111 of the retainer portion 110 is substantially perpendicular to the longitudinal axis 18 and forms a planar surface to engage a bottom surface of the seat 64 as shown in FIGS. 2B and 3. The words “inward” and “outward” refer to directions toward and away from, respectively, the longitudinal axis 18. A second retainer surface 112 extends from the outward most point of the first retainer surface 111 and parallel to the longitudinal axis 18 towards a third retainer surface 113 of the retainer portion 110. The third retainer surface 113 may be at an oblique angle to the longitudinal axis 18. A fourth retainer surface 114, contiguous to the third retainer surface 113, is orthogonal to the longitudinal axis 18 and substantially parallel to the first retainer surface 111. The four retainer surfaces form a flange 115 at the outer circumference of the retainer portion 110.

The retainer portion 110 includes a portion, i.e., flange 115, internally mounted to the gaseous fuel injector 10 proximate the outlet 14. The flange 115 of the retainer portion 110 is secured by a securement portion 90 of the body 50.

The flow modifier portion 120 affects the flow distribution pattern of gaseous fuel through the internally mounted nozzle 100 as shown in FIG. 2 by the dashed outline of a gaseous fuel cloud. In one embodiment, the flow modifier portion 120 defines a flow passage 121 that is in fluid communication with the seat orifice 76 and extends along a first flow modifier surface 122 disposed about the longitudinal axis 18. The flow passage 121 extends to a first flow channel 123 defined by second flow modifier surface 125 located within the internally mounted nozzle 100, as shown in FIG. 2B.

The first flow channel 123 extends along a first axis 126a or second axis 126b at a flow angle θ₁ relative to axis 18. Preferably, the flow angle θ₁ is generally orthogonal to the longitudinal axis 18 as shown in FIG. 2B. The first flow channel 123 directs gaseous fuel to discharge the internally mounted nozzle 100. Preferably, the first flow channel 123 is generally circular in cross-section and has an inside diameter of about 2 millimeters such that a column of fuel flowing out of the flow channel is in the form of a cone.

In one preferred embodiment, illustrated in FIG. 2B, a second flow channel may extend along the first axis 126a, but in a direction diametrically opposed to the first channel 124. In another preferred embodiment of the present invention, a third flow channel 128 and a fourth flow channel 129 may be extended along a second axis 126b that is generally orthogonal to the longitudinal axis 18 of the internally mounted nozzle 100, as shown in FIG. 2B. The third and fourth flow channels can be diametrically opposed to each other and may be generally circular in cross-section as shown in FIG. 2B.

Gaseous fuel flows through the seat orifice 76, along the flow passage 121, and may be dispersed through one, two, three, four, or other multiple flow channel configurations of the internally mounted nozzle 100. Thus, the resulting multiple columns of gaseous fuel are dispersed perpendicular to the longitudinal axis 18 of the gaseous fuel injector 10 to improve the mixing characteristics within the intake manifold.

It is believed that at least the preferred embodiments described above in relation to the nozzle 100 alleviate back-flow of the air-fuel mixture into the internal combustion engine's intake plenum or into other engine cylinders in that the preferred embodiments provide a cloud of gaseous fuel, which can be entrained by the airflow towards the intake for dispersal into the combustion chamber. The discharge pattern of gaseous fuel delivered to the intake manifold of the present invention is believed to improve the air-fuel mixture and drivability problems in certain applications.

In another preferred embodiment, illustrated in FIG. 3, a nozzle 100′ is provided only with the second flow modifier surface 125. The surface 125 may be disposed about an oblique axis 130 to the longitudinal axis 18 and gaseous flow discharged through a singular oblique flow channel 131. The oblique flow channel angled at an oblique angle θ₂ oblique to the longitudinal axis 18 may vary in range from 10° to 45°. However, the preferred θ₂ is approximately 26°. The above-mentioned singular oblique flow channel 131 delivers a single conical column of gaseous fuel to the intake manifold at angle θ₂ with respect to the longitudinal axis 18 so that in conjunction with an intake manifold geometry, the fuel injector is able to improve its mixing characteristics with air flow in the manifold. The preferred pressure at which the gaseous fuel injector 10 operates is approximately 200 pounds per square inch gauge pressure and a pressure drop of no more than five pounds per square inch gauge is expected across the nozzle.

It should be noted that even though the external nozzle 100 has been illustrated as a monolithic structure, the nozzle 100 can be formed by securing two or more portions of the nozzle 100 together. For example, the retainer portion 110 and flow modifier portion 120 can be separate structures secured to each other by a suitable technique, such as, for example, welding, laser welding, friction welding or bonding.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. A fuel injector comprising:
an inlet and an outlet and a passage extending along a longitudinal axis from the inlet to the outlet, the inlet communicable with a flow of gaseous fuel;
a closure member disposed in at least two positions along the longitudinal axis in the passage, the closure member having an imperforate contact portion proximate the outlet;
a seat disposed in the passage proximate the outlet, the seat including a sealing surface contiguous to the imperforate contact portion of the closure member in one position of the closure member to occlude flow through a seat orifice extending through the seat from the sealing surface along the longitudinal axis; and
a flow modifier having a retainer portion and flow modifier portion, the retainer portion being contiguous to an inner surface of the body such that the flow modifier portion extends outside the body, the flow modifier including:
a first flow modifier surface and a second flow modifier surface, the first flow modifier surface disposed about the longitudinal axis to define a flow passage in fluid communication with the seat orifice, and the second flow modifier surface being disposed along and about a first axis at an angle with respect to the longitudinal axis to define at least a flow channel.

2. The fuel injector of claim 1, wherein the angle comprises about 90 degrees with respect to the longitudinal axis.

3. The fuel injector of claim 2, wherein the second flow modifier surface further comprises a second flow channel diametric to the first flow channel along the first axis.

4. The fuel injector of claim 3, wherein the second flow modifier surface further comprises third and fourth flow channels aligned along a second axis orthogonal to the first and longitudinal axes.

5. The fuel injector of claim 3, wherein each of the flow channels comprises a flow channel having a generally circular cross-section about respective first and second axes.

6. The fuel injector of claim 5, wherein the second flow modifier surface comprises a surface cincturing the first axis to define a cylindrical flow channel surface.

7. The fuel injector of claim 6, wherein the flow passage comprises a perimeter contiguous to a perimeter of the seat orifice.

8. The fuel injector of claim 7, wherein the retainer portion comprises a portion with an outer diameter of about 9 millimeters.

9. The fuel injector of claim 8, wherein flow passage comprises a flow passage having a length selected from a group comprising one of 2 millimeters, 4 millimeters, 6 millimeters, 8 millimeters and variations therein.

10. The fuel injector of claim 9, wherein the flow channel surface comprises a cylinder with an inside diameter of about 2 millimeters.

11. The fuel injector of claim 1, wherein the angle comprises an oblique angle with respect to the longitudinal axis.

12. The fuel injector of claim 11, wherein the oblique angle comprises an angle of about 26 degrees.

13. The fuel injector of claim 12, wherein the second modifier surface comprises a surface cincturing the first axis to define a cylindrical surface having an inside diameter of about 2 millimeters.

14. A method of dispersing gaseous fuel from a fuel injector having an inlet and an outlet and a passage extending along a longitudinal axis from the inlet to the outlet, a closure member disposed in at least two positions along the longitudinal axis in the passage, a seat disposed in the passage proximate the outlet having a seat orifice extending through the seat, and a flow modifier, the method comprising:
preventing fluid communication past the seat with an imperforate portion of the closure member contiguous the seat;
locating a portion of a flow diverter within the fuel injector;
flowing gaseous fuel through the flow diverter; and
dispersing the gaseous fuel into at least one column of gaseous fuel that extends at a first angle with respect to the longitudinal axis.

15. The method of claim 14, wherein the dispersing comprises dispersing the gaseous fuel into four conical columns, each conical column being oriented at a first angle generally perpendicular to the longitudinal axis.

16. The method of claim 14, wherein the dispersing comprises dispersing the gaseous fuel at an oblique angle with respect to the longitudinal axis.

17. The method of claim 16, wherein the first angle comprises 26 degrees.
